(19) United States
(12) Patent Application Publication
(10) Pub. No.: US 2008/0050520 A1
(43) Pub. Date: Feb. 28, 2008

(54) Latex composition, latex foam, latex foam products and methods of making same

(75) Inventors: Eugene T. Hubbuch, Signal Mountain, TN (US); Claude R. Roe, Calhoun, GA (US); Alan P. Sellers, Rocky Face, GA (US)

Correspondence Address: KING & SPALDING LLP, 1180 PEACHTREE STREET, ATLANTA, GA, 30309-3521, US

(73) Assignee: Textile Rubber & Chemical Company, Inc.

(21) Appl. No.: 11/699,621

(22) Filed: Jan. 29, 2007

Related U.S. Application Data
(63) Continuation-in-part of application No. 11/510,256, filed on Aug. 25, 2006.

(51) Int. Cl. B05D 5/00; B05D 3/02; C08J 9/30

(52) U.S. Cl. 427/244; 427/372.2; 521/65

(57) ABSTRACT

The invention comprises a latex formulation. The latex formulation comprises an aqueous emulsion of a natural or synthetic film-forming polymer, hydrogen peroxide, a surfactant and an activating agent for hydrogen peroxide decomposition. A method of making a latex foam, a method of making a latex-coated textile material, a latex foam and latex foam coated articles are also disclosed.

### CROSS-REFERENCE TO RELATED APPLICATIONS

This application is a continuation-in-part of application Ser. No. 11/510,256 filed Aug. 25, 2006.

### FIELD OF THE INVENTION

The present invention generally relates to latex foam. More particularly, this invention relates to latex foam made with a novel foaming agent and a novel process, which provides the foam with unexpected properties and characteristics. The present invention also relates to textile materials, such as carpet backing, coated with the latex foam of the present invention and to methods of making such foam and applying it to textile materials.

### BACKGROUND OF THE INVENTION

Textile materials, such as carpet backings, are frequently coated with latex foam to provide desired properties to the textile materials. One method of producing a latex foam is to incorporate a low-boiling organic material and surfactants into the latex formulation. After the latex formulation is heated, the low-boiling organic material vaporizes, thereby producing a foam. However, such a process is currently disfavored because of the release of volatile organic compounds (“VOCs”) into the environment.

Another method of producing latex foam typical used today is to incorporate surfactants into the latex formulation and then process the latex formulation in a frothing machine. The frothing machine whips air into the latex formulation, thereby producing a frothed latex foam. The frothed latex foam can then be shaped into a desired form, cured and dried. Alternately, the frothed latex foam can be deposited on a textile material and shaped into a layer coating the textile material. The frothed foam can then be cured and dried on the textile material, thereby forming a foam-coated textile product.

One disadvantage of using frothed latex foam is the amount of energy needed to cure and dry the latex foam. Typically, frothed latex foams cannot have a solids content of greater than approximately 75% by weight. Thus, the drying process requires the removal of 25% by weight or more of water, which requires a large amount of heat energy to accomplish. Furthermore, with frothed latex foams, it is usually necessary to expose the frothed latex foam to a bank of infrared heaters directed toward the exposed surface of the latex foam in order to quickly set the latex foam to thereby preserve the foam structure. Such infrared heaters also consume large amounts of energy.

It would, therefore, be desirable to provide a latex foam that requires lower amounts of energy to process, does not produce VOCs and can be processed relatively quickly and efficiently.

### SUMMARY OF THE INVENTION

The present invention satisfies the foregoing needs by providing a composition comprising a mixture of an aqueous emulsion of a natural or synthetic film-forming polymer; hydrogen peroxide; and an activating agent which causes the hydrogen peroxide to decompose thereby releasing oxygen gas which produces a foam.

In an alternate embodiment, the present invention comprises a textile material with a coating of a composition comprising a mixture of an aqueous emulsion of a natural or synthetic film-forming polymer; hydrogen peroxide; and an activating agent which causes the hydrogen peroxide to decompose thereby releasing oxygen gas which produces a foam.

In another aspect, the present invention provides a method of making a foam comprising combining an aqueous emulsion of a natural or synthetic film-forming polymer, hydrogen peroxide and an activating agent, whereby the activating agent causes the hydrogen peroxide to release oxygen gas in the emulsion which produces a foam.

In another alternate embodiment, the present invention comprises a method of making a foam-coated textile material comprising applying to a textile material a composition comprising a mixture of an aqueous emulsion of a natural or synthetic film-forming polymer; hydrogen peroxide; and an activating agent which causes the hydrogen peroxide to decompose thereby releasing oxygen gas which produces a foam.

Accordingly, it is an object of the present invention to provide an improved latex foam.

Another object of the present invention is to provide a latex coated textile material having improved properties.

Still another object of the present invention is to provide a tufted carpet product having a latex foam coating on the backing thereof which produces improved bundle encapsulation/penetration, stitch/fiber lock, wet tuft bind, lamination strength, and/or dimensional stability.

Still another object of the present invention is to provide a latex foam that does not involve the production of VOCs.

These and other objects, features and advantages of the present invention will become apparent upon reviewing the following detailed description of the disclosed embodiments and the appended drawing and claims.

### BRIEF DESCRIPTION OF THE DRAWINGS

FIG. 1 is a disclosed embodiment of a carpet product in accordance with the present invention.

FIG. 2 is a side schematic view of a disclosed embodiment of an apparatus for manufacturing latex coated carpet in according with the present invention.

### DETAILED DESCRIPTION OF THE DISCLOSED EMBODIMENTS

The term latex is known by those skilled in the art to mean an aqueous emulsion of natural or synthetic rubber or plastic (synthetic polymer) globules. That is, water forms the continuous phase of the emulsion and natural or synthetic rubber or film-forming polymers form the discontinuous phase.

The term decomposition as applied to hydrogen peroxide and as used herein means that the hydrogen peroxide undergoes the chemical reaction shown below:

2H₂O₂(aq)→2H₂O(l)+O₂(g)

The term “activating agent” as used herein means any substance that causes hydrogen peroxide to undergo the chemical reaction shown above and described as decomposition.

The present invention provides improved bundle encapsulation/penetration, stitch/fiber lock, wet tuft bind, lamination strength, and/or dimensional stability when applied to textiles, such as tufted carpet, including scatter rugs as well as broadloom carpet.

The formulation of the present invention that can be used to make the foam of the present invention comprises a mixture of an aqueous emulsion of a natural or synthetic film-forming polymer, hydrogen peroxide and an activating agent for the decomposition of the hydrogen peroxide. The formulation includes a sufficient amount of hydrogen peroxide such that when the hydrogen peroxide decomposes it releases enough oxygen gas to convert the formulation to a foam. The formulation includes a sufficient amount of activating agent such that it causes the hydrogen peroxide to decompose at a desired rate and produces a desired amount of oxygen gas to convert the formulation to a foam.

A typical formulation in accordance with the present invention is shown in Table 1 below.

TABLE 1

| Polymer | Parts by Weight | Percent by weight |
|---|---|---|
| Natural Rubber latex* | 0–100 | 0–44.64 |
| Synthetic Rubber latex* | 0–100 | 0–44.64 |
| Activating agent | 0.1–4 | 0.1–1.78 |
| Hydrogen Peroxide | 1–20 | 0.98–8.93 |
| Surfactant | 0.002–6 | 0.0025–3 |

*The amount of natural rubber latex and synthetic rubber latex cannot both be zero.

Aqueous emulsions or solutions of film-forming natural or synthetic polymers (both homopolymers and copolymers) useful in the present invention include, but are not limited to, styrene-butadiene latex, carboxylated styrene-butadiene latex, ethylene vinyl acetate latex, polyvinyl acetate latex, polyvinyl chloride latex, chloroprene latex, neoprene latex, silicone rubber dispersion, natural rubber latex, polyvinyl alcohol solution, polyvinyl alcohol solution stabilized with bromine, acrylic latex, styrene acrylic latex, vinyl acrylic latex, and compatible mixtures thereof. The amount of the aqueous emulsion of film-forming natural or synthetic polymers used in the formulation of the present invention depends on the type of application for which the foam will be used. Preferably, the amount of an aqueous emulsion of film-forming natural or synthetic polymers useful in the present invention is about 60% to about 99% by weight of the formulation; especially, about 15% to about 50% by weight of the formulation.

Prior art latex formulations typically have been a blend of natural and synthetic rubber latex, such as 60% to 90% by weight natural rubber latex and 10% to 40% by weight synthetic rubber latex. It is specifically contemplated as a feature of the present invention that the formulation of the present invention can be made from 100% synthetic rubber latex, such as 100% styrene-butadiene latex.

The amount of hydrogen peroxide used in the formulation of the present invention depends on the type of application for which the foam will be used. Preferably, the amount of hydrogen peroxide useful in the present invention is about 0.5% to about 40% by weight of the formulation; especially about 1% to about 10% by weight of the formulation.

Activating agents useful in the present invention are any material that catalyzes the decomposition of hydrogen peroxide. Activating agents useful in the present invention include, but are not limited to, enzymes, proteins and oxidizing/reducing agents. The amount of activating agent used in the formulation of the present invention depends on the type of application for which the foam will be used. Preferably, the amount of activating agent useful in the present invention is about 0.05% to about 5% by weight of the formulation; especially, about 0.1% to about 1% by weight of the formulation.

Any protein that catalyzes the decomposition of hydrogen peroxide can be used. The enzymes listed below are all proteins. Other proteins useful in the present invention include, but are not limited to, casein. Yeasts, such as Saccharomyces cerevisiae (better known as Baker's yeast), can be used as an activating agent in the present invention.

Any enzyme that catalyzes the decomposition of hydrogen peroxide can be used. Enzymes useful in the present invention include, but are not limited to, catalase, chymotrypsin, lipase, rennet, trypsin, actinidin, α-amylase, β-amylase, bromelain, β-glucanase, ficin, lipoxygenase, papain, asparaginase, glucose isomerase, penicillin amidase, protease, pullulanase, aminoacylase, glucoamylase, cellulase, dextranase, glucose oxidase, lactase, pectinase, pectin lyase, protease, raffinase, invertase, and mixtures thereof.

Any oxidizing/reducing agent that catalyzes the decomposition of hydrogen peroxide can be used. Oxidizing/reducing agents useful in the present invention include, but are not limited to, CuCl₂, CuO, ZnO, MnO₂, KI, and Fe(II) and Fe(III) oxides. Iron oxide-bearing clays, such as montmorillonite K10, can also be used as a source of an activating agent.

Surfactants that can be used in the present invention are any surfactant that is compatible with the aqueous emulsions or solutions of film-forming natural or synthetic polymers and other components of the formulation of the present invention and provide sufficient foam strength to maintain the foam structure until the foam is cured. Surfactants that can be used in the present invention include non-ionic and anionic surfactants. Non-ionic surfactants useful in the present invention include, but are not limited to, linear or nonyl-phenol alcohols, such as t-octylphenoxypolyethoxyethanol and/or fatty acids. Anionic surfactants useful in the present invention include, but are not limited to, ether sulphates, such as sodium lauryl sulfate or ammonium lauryl sulfate; ether phosphates, such as ethoxylated succinates; sulphosuccinates, such as disodium N-octadecyl sulfosuccinamate (Aerosol 18 available from Tiarco, Dalton, Ga.) and tetrasodium N-(1,2-dicarboxyethyl)-N-octadecyl sulfosuccinamate (Aerosol 22 available from Tiarco, Dalton, Ga.); ether carboxylates or ammonium, sodium or potassium salts of caprylic, laurate, oleate or stearic acids. Specific surfactants desired for use in the present invention include, but are not limited to, stearic acid, t-octylphenoxypolyethoxyethanol (Triton X-100), potassium behenate, sodium sulphosuccinate, and ammonium lauryl sulfate. Surfactants can be used in the formulation of the present invention in amounts sufficient to form a stable foam during curing and drying. Such surfactants can be added in amounts of about 0.0025% to about 3% by weight of the formulation; preferably, about 0.006% by weight of the formulation.

The formulation of the present invention can also include various additives to improve or adjust the properties of the foam as desired. Such additives can include, but are not limited to, fillers, thickening agents, gelling agents, vulcanizing agents, accelerators, antimicrobial agents, and other additives typically included in prior art latex foam formulations.

Typical gelling agents used for latex formulations can be used in the formulation of the present invention. Such gelling agents include, but are not limited to, sulfur-containing compounds, chlorides, acetates; fluorides; and zinc salts know as gelling agents. The amount of gelling agent used in the formulation of the present invention is an amount sufficient to cause the formulation to gel within a desired time. Such amounts include, but are not limited to, about 0.2% by weight to about 6% by weight of the formulation. A time-based gelling agent, such as sodium silica fluoride, is preferred. A particularly preferred formulation includes about 10 weight parts of an aqueous emulsion of a film forming polymer, about 4 weight parts hydrogen peroxide, about 1 weight part gelling agent and about 0.1 weight parts activating agent.

Typical ingredients used as fillers in the composition of the present invention include, but are not limited to, aluminum trioxide, such as P-130A available from Custom Grinders Sales, Inc., Chatsworth, Ga.; aluminum silicate, such as LU-400 available from Lawson-United Feldspar & Mineral Co./K-T Feldspar, Spruce Pine, N.C.; calcium carbonate, such as 200-W available from Georgia Marble Company, Dalton, Ga.; magnesium hydroxide, such as MagneClear 58 available from Martin Marietta Magnesia Specialties, Inc., Baltimore, Md.; fiberglass available from JPS, South Carolina; Portland cement; barites; fly ash; ground glass (i.e., glass cullet), rubber crumb, and other inorganic materials. Filler amounts used in the formulation of the present invention are preferably about 0% to about 70% by weight of the formulation; especially, about 45% to about 55% by weight of the formulation. Flame retardant fillers or flame retardant additives, such as magnesium hydroxide or aluminum trihydrate, can also be added to the formulation. Such flame retardant fillers or flame retardant additives can be added in amounts of approximately 0% to 70% by weight of the formulation.

Antimicrobial additives can be added to help control mold and mildew growth in wet environments. Such antimicrobial additives can be added in amounts of approximately 0% to 10% by weight of the formulation. Also, scents or odor eliminators can be added to the formulation. Such scents or odor eliminators can be added in amounts of approximately 0% to 15% by weight of the formulation.

Depending on the desired physical properties of the finished foam or foam-coated textile, other materials can be incorporated into the formulation to achieve the desired effect, while maintaining the performance of the foam.

It is specifically contemplated as a feature of the present invention that the formulation of the present invention can have a solids content of greater than 75% by weight. It is specifically contemplated that the formulation of the present invention can have a solids content of up to about 87% by weight. The higher solids content of the formulation of the present invention permits the use of less water in the formulation which, in turn, permits more rapid drying of the formulation and/or the use of less heat energy to dry the formulation.

Another feature of the formulation of the present invention is that it requires less surfactant than prior art latex formulations. Since surfactants are relatively expensive ingredient, this feature provides a significant cost savings.

Table 2 below shows preferred ranges of the ingredients of a disclosed embodiment of the formulation of the present invention.

TABLE 2

| Polymer | Parts by Weight | Percent by weight |
|---|---|---|
| Natural rubber latex | 20–100 | 9.84–17.98 |
| Synthetic rubber latex | 80–100 | 39.38–17.98 |
| Filler | 100–400 | 49.22–53.95 |
| Thickening agent | 0.05–4 | 0.025–0.72 |
| Accelerator | 1–15 | 0.5–2.7 |
| Vulcanizer | 0.25–3 | 0.125–0.54 |
| Gellant | 0.25–5 | 0.12–0.9 |
| Other Additives | 0.5–5 | 0.25–0.9 |
| Activating agent | 0.1–4 | 0.05–0.72 |
| Hydrogen Peroxide | 1–20 | 0.5–3.6 |
| Surfactant | 0.004–6 | 0.0025–3 |

It has been further discovered that the inclusion of starch, stearic acid or combinations thereof, improves the retention of gas bubbles within the formulation of the present invention, thereby making the foam more stable. Starches useful in the present invention include, but are not limited to, starch from fruits, seeds, rhizomes or tubers of plants. Preferred starches are corn starch, potato starch, rice starch and wheat starch. Salts of stearic acid include, but are not limited to, salts of alkali metals and salts of alkaline earth metals, such as potassium stearate, sodium stearate, zinc stearate and magnesium stearate. The amount of starch, stearic acid or salts of stearic acid included in the formulation is an amount sufficient to improve the gas bubble retention within the foam; preferably about 0.002% to about 3% by weight of the formulation; especially, about 0.22% to about 1% by weight of the formulation.

Another feature of the present invention is the ability to very precisely control the amount of blowing of the foam. By controlling the amounts of the hydrogen peroxide and the activating agent in the formulation and the ratio of the activating agent to the hydrogen peroxide, the amount of blowing, and, therefore, the amount of foam generation, can be precisely determined, controlled and reproduced.

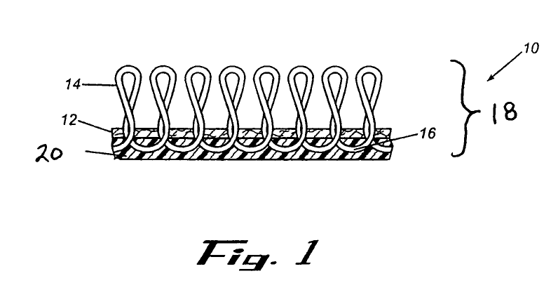

With reference to the drawing in which like numbers indicate like elements throughout the several views, it will be seen that there is disclosed a floor covering product, such as a carpet 10 (FIG. 1), in accordance with the present invention. The carpet 10 comprises a primary backing material 12 through which loops of yarn are tufted in order to form a face pile 14 on one side of the primary backing material. The face pile 14 may be looped, as shown in FIG. 1, or it may be cut (not shown). The yarn forming the face pile 14 can be any suitable fiber, or blend of fibers, typically used in broadloom carpets, bath mats, scatter rugs, nonwovens, or the like, including, but not limited to, nylons; polyolefins, such as polypropylenes and polyethylenes; polyesters, polyethylene terephthalate or combinations thereof and natural fibers, such as cotton. The primary backing material 12 can be made from any synthetic or natural material suitable for tufting, including, but not limited to, polyester, polypropylene, polyethylene, nylon, fiberglass or combinations thereof.

Collectively, the face pile 14, the primary carpet backing 12 and the loop backs 16 form a facing layer 18. While the facing layer 18 of the carpet 10 has been illustrated in FIG. 1 as a tufted carpet product, the facing layer can be of any desired construction and composition. Such facing layer 18 can comprise, for example, a knitted, woven, or nonwoven textile product of natural or synthetic materials. The facing layer 18 advantageously has a weight of about 0.9 to about 85 ounces per square yard; preferably, about 2 to 80 ounces per square yard. Furthermore, although the present invention is illustrated as a foam coating for a carpet backing, it is specifically contemplated that the latex foam of the present invention can be applied to other textile materials, such as knitted, woven or nonwoven fabrics.

With further reference to FIG. 1, the carpet 10 also comprises a layer of foam 20 in accordance with the present invention. The foam layer 20 is formed on the side of the primary backing 12 opposite the face pile 14. The foam layer 20 also contacts the loop backs 16 securing them to the primary backing 12. Alternately, in the case of knitted, woven or nonwoven facing layers, the foam layer 20 adheres to the back surface of the facing layer 18. The foam layer 20 is applied to the back surface of the facing layer 18 in amounts of approximately 1 to 50 ounces per square yard; preferably, about 4 to about 36 ounces per square yard; especially, about 17 to about 28 ounces per square yard.

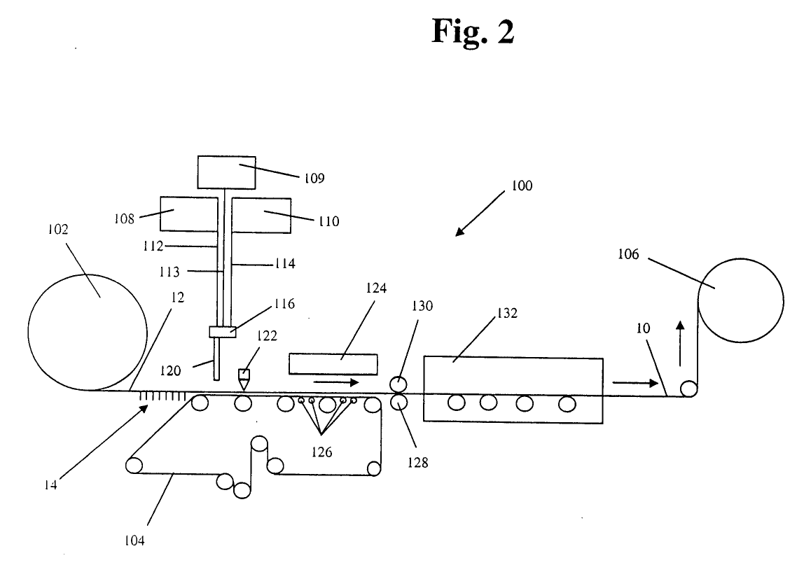

With reference to FIG. 2, there is disclosed an apparatus 100 for making the carpet 10 shown in FIG. 1. The process for making the carpet 10 comprises feeding the griege textile product or facing layer 18; i.e., the tufted primary backing 12 having a downwardly extending face pile 14, from a supply roll 102 onto a moving conveyor 104 that advances the floor covering product from the supply roll to a take-up roll 106.

Contained in the storage tank 108 is the latex rubber formulation. Separately contained in the tank 109 is the hydrogen peroxide. Separately contained in the storage tank 110 is the activating agent formulation.

The storage tanks 108, 109, 110 are connected via hoses 112, 113, 114 respectively, to a monitored static mixer 116. Precise ratios of the latex rubber formulation, hydrogen peroxide and activating agent formulation can be delivered to the mixer 116 by metering pumps (not shown). The mixer 116 combines and mixes the latex rubber formulation, the hydrogen peroxide and the activating agent formulation when the latex formulation, the hydrogen peroxide and the activating agent formulation are combined in the mixer 116, the activating agent immediately causes the hydrogen peroxide to begin to decompose.

The mixer 116 is connected to a flexible hose 118 for depositing the formulation of the present invention onto the primary backing 12 of the facing layer 18. The hose 120 is attached to a traversing trolley (not shown) which moves the end of the hose across the width of the facing layer 18 so that a puddle (not shown) of the latex formulation is deposited on the primary backing 12. As the facing layer 18 advances toward the take-up roll 106, the puddle of latex formulation on the surface of the primary backing 12 passes under a doctor bar 122, which shapes the latex formulation on the primary backing into a layer of a desired thickness. Thus, after the primary backing 12 passes under the doctor bar 122, the primary backing has a coating of the latex formulation of a desired thickness. Since the distance between the point where the latex formulation is deposited on the primary backing 12 and the doctor bar 122 is relatively short and since the activating agent and the hydrogen peroxide were not combined until they reached the mixer 116, only a relatively small amount of blowing occurs in the latex formulation until after it is shaped into the coating layer on the primary backing.

After the formulation is shaped into the coating layer on the primary backing 12, the hydrogen peroxide which continues to decompose, produces a sufficient amount of oxygen gas so as to convert the coating layer on the primary backing into a layer of foam 20.

Optionally, the apparatus 100 can include a bank of infrared heaters 124 disposed above the primary backing 12. The infrared heaters 124 heat the layer of latex formulation on the primary backing 12 to a temperature of approximately 150° to 600° F. By adding heat to the layer of latex formulation on the primary backing 12, blowing and curing of the latex formulation is accelerated. The use of the infrared heaters 124 permits the production speed of the carpet 10 to be increased.

Optionally, the apparatus 100 also includes heating coils 126 disposed below the conveyor 104. The heating coils 126 are connected to a source (not shown) of either heated water or steam, which is circulated through the heating coils. The heating coils 126 provide heat to the facing layer 18 disposed on the conveyor 104 and to the latex formulation coating thereon. By adding heat to the layer of latex formulation on the primary backing 12 blowing and curing of the latex formulation is accelerated. The use of the heating coils 126 also permits the production speed of the floor covering product to be increased.

Optionally, the apparatus 100 further includes a pair of nip rollers 128, 130. The nip rollers 128, 130 apply pressure to the latex foam formulation coated-primary backing 12, thereby forcing a portion of the latex formulation coating into the primary backing and into the loop backs 16 of the tufts 14, thereby improving bundle encapsulation/penetration, stitch/fiber lock, wet tuft bind, lamination strength, and dimensional stability. Optionally, the roller 130 can be an embossed roller, which can thereby imprint a desired pattern, such as a waffle pattern, in the latex foam formulation coating on the primary backing 12.

The foam-coated carpet facing layer 18 then advances through a hot air oven 132. The hot air oven 132 dries and cures the foam coating on the facing layer 18. The temperature of the hot air oven depends on the formulation used, the thickness of the foam and the speed of the production line. However, the temperature of the hot air oven 132 is about 200° F. to about 400° F.; preferably, about 240° F. to about 350° F. Residence time of the floor covering product 10 in the hot air over 132 is about 1 minute to about 10 minutes or more; preferably, about 2 minutes to about 8 minutes.

After the foam coating on the floor covering product is cured and dried in the hot air oven 132, the floor covering product advances to the take-up roll 106. The carpet 10 is then rolled into a roll and cut to length for packaging.

The following examples are intended to illustrate the present invention, but are not intended to limit the scope of the present invention as set forth in the claims.

### EXAMPLE 1

A formulation suitable for use in the present invention is prepared as described below. Table 3 shows the latex portion of the formulation.

TABLE 3

| Ingredient | Dry Weight | % Solids | Wet Weight |
|---|---|---|---|
| Synthetic Rubber latex | 30 | 70 | 42.857 |
| K-Stearate | 0.650 | 20 | 3.250 |
| Tall Oil Soap | 2 | 15 | 13.333 |
| HA, LA Natural Rubber latex | 70 | 62 | 112.903 |
| Wingstay L | 1 | 50 | 2 |
| paraffin wax | 1 | 50 | 2 |
| TiO2/titanium dioxide | 0.6 | 60 | 1 |
| Violet blue 369/ultramarine blue | 0.030 | 100 | 0.030 |
| Whiting CC103BLK | 200 | 100 | 200 |
| T-gum AHG Tiarco/polyacrylate | 0.1 | 10 | 1 |
| 30% S.S.F. | 2.4 | 30 | 8 |

In Table 3 above, Synthetic Rubber latex, e.g., Butanol NS-104 cold latex, is a cold polymerized styrene-butadiene latex polymer, commercially available from BASF Corporation, Florham Park, N.J.; K-Stearate is potassium stearate; Tall Oil Soap is rosin oil, commercially available from Westvaco Corporation, New York, N.Y.; HA, High Ammonia, or LA, Low Ammonia Natural Rubber is natural rubber latex, commercially available from Firestone Natural Rubber Company, Indianapolis, Ind. Wingstay L is polymer stabilizer, commercially available from Eliochem, Akron, Ohio; Paraffin Wax emulsion is commercially available from Tiarco Chemical, Dalton, Georgia; TiO₂ is commercially available from Rychem, Atlanta, Ga.; Violet blue 369/ultramarine blue is a pigment, commercially available from Organic Pigments, Spartanburg, S.C.; Whiting CC103BLK is a filler commercially available from Imerys, Roswell, Ga.; T-gum AHG Tiarco is a polyacrylate commercially available from Textile Rubber & Chemical Company, Inc., Dalton, Ga.; 30% S.S.F. is sodium silica flouride, commercially available from Lynx Chemical, Dalton, Ga.

The ingredients in Table 3 are blended together in a propeller-type mixer. The latex formulation (Table 3) is stored in tank 108 (FIG. 2). Hydrogen peroxide (35% by weight) is stored in tank 109.

Table 4 shows the activating agent/accelerator portion of the formulation.

TABLE 4

| | Dry | | |
|---|---|---|---|
| Ingredient | Weight | % Solids | Wet Weight |
| Water | 0 | 0 | 5 |
| Tamol 731A | 0.13 | 25 | 0.52 |
| Zinc Oxide | 5 | 100 | 5 |
| rubber maker Sulfur | 1.8 | 65 | 2.769 |
| ZBDC, ZEDC, or ZBZ (carbamate | 1.4 | 42 | 3.333 |
| accelerator) | | | |
| ZMBT | 1.05 | 55 | 1.909 |
| Tall Oil Soap | 0.2 | 15 | 1.333 |
| Octosol A-18 | 0.1 | 35 | 0.286 |
| Octosol 571 | 0.15 | 50 | 0.3 |
| Catalase enzyme | 1 | 100 | 1 |
| Karaya-Gum | 0.04 | 4.5 | 0.889 |
| T-Gum AHG Tiarco/polyacrylate | 0.02 | 10 | 0.2 |

In Table 4 above, Tamol 731A is a sodium salt polyelectrolyte, commercially available from Rohm & Haas Corporation, Philadelphia, Pa.; Zinc Oxide is French process zinc oxide, commercially available from Horsehead Corporation, Monaca, Pa.; Sulfur is rubber maker sulfur, commercially available from Georgia Gulf Sulfur, Houston, Tex.; ZBDC (zinc dibutyl dithiocarbamate), ZEDC (zinc ethyl dithiocarbamate), ZBZ (zinc dibenzyldithiocarbamate) are carbamate accelerators, commercially available from R. T. Vanderbilt, Norwalk, Conn.; ZMBT is zinc mercaptobenzothiazole, commercially available from Chemtura, Waterbury, Conn.; Tall oil Soap is oleate rosin oil, commercially available from Westvaco Corporation, New York, N.Y. Octosol A-18 is a succinamate surfactant, commercially available from Tiarco Chemical, Dalton, Ga.; Octosol 571 is quaternary chloride, commercially available from Tiarco Chemical, Dalton, Ga.; Catalase enzyme is a liver-based (animal) enzyme, commercially available from Genencor International, Mocksville, N.C.; and Karaya-Gum is a thickener.

The ingredients in Table 4 are blended together in a propeller-type mixer. The activating agent/accelerator formulation (Table 4) is stored in tank 110 (FIG. 2). Hydrogen peroxide (35% by weight) is stored in tank 109.

The latex formulation in tank 108, the hydrogen peroxide stored in tank 109 and the activating agent/accelerator formulation in tank 110 are fed to the monitored static mixer 116 (FIG. 2). The ratio of the latex formulation and the activating agent/accelerator formulation are such that 10.89 dry weight parts or 22.537 wet weight parts of the activating agent/accelerator formulation (Table 4) are added to the latex formulation (Table 3) at the mixer 116. The ratio of the hydrogen peroxide and latex formulation are such that 5 wet weight parts hydrogen peroxide are added to the latex formulation at the mixer 116. After mixing in the mixer 116, the formulation is applied to the tufted carpet primary backing 12 in the manner described above. The tufted carpet 10 is processed as described above using the apparatus 100, shown in FIG. 2.

The formulation makes a latex foam on the carpet primary backing 12, as described above with respect to FIG. 2. The resulting tufted carpet has an integral foam backing and has excellent properties of bundle penetration and tuft lock.

### EXAMPLE 2

A formulation suitable for use in the present invention is prepared as described below. Table 5 shows the latex portion of the formulation.

TABLE 5

| | Dry | | Wet |
|---|---|---|---|
| Ingredient | Weight | % Solids | Weight |
| Synthetic Rubber latex | 70 | 70 | 100 |
| K-Stearate | 0.650 | 20 | 3.250 |
| Tall Oil Soap | 2 | 15 | 13.333 |
| HA, LA Ammonia Natural Rubber latex | 30 | 62 | 48.387 |
| Wingstay L | 1 | 50 | 2 |
| paraffin wax | 1 | 50 | 2 |
| TiO2/titaniam dioxide | 0.6 | 60 | 1 |
| Violet blue 369/ultramarine blue | 0.030 | 100 | 0.030 |
| Whiting CC103BLK | 250 | 100 | 250 |
| T-gum AHG Tiarco/polyacrylate | 0.1 | 10 | 1 |
| 30% S.S.F. | 2.4 | 30 | 8 |

The ingredients in Table 5 are blended together in a propeller-type mixer. The latex formulation (Table 5) is stored in tank 108 (FIG. 2). 35% by weight hydrogen peroxide is stored in tank 109.

Table 4 above shows the activating agent/accelerator portion of the formulation. The ingredients in Table 4 are blended together in a propeller-type mixer. The activating agent/accelerator formulation is stored in tank 110 (FIG. 2).

The latex formulation in tank 108, the hydrogen peroxide stored in tank 109 and the activating agent/accelerator formulation in tank 110 are fed to the monitored static mixer 116 (FIG. 2). The ratio of the latex formulation and the activating agent/accelerator formulation are such that 10.89 dry weight parts or 22.537 wet weight parts of the activating agent/accelerator formulation (Table 4) are added to the latex formulation (Table 3) at the mixer 116. The ratio of the hydrogen peroxide and latex formulation are such that 5 wet weight parts hydrogen peroxide are added to the latex formulation at the mixer 116. After mixing in the mixer 116, the formulation is applied to the tufted carpet primary backing 12 in the manner described above. The tufted carpet 10 is processed as described above using the apparatus 100, shown in FIG. 2.

The formulation makes a latex foam on the carpet primary backing 12, as described above with respect to FIG. 2. The resulting tufted carpet has an integral foam backing and has excellent properties of bundle penetration and tuft lock.

### EXAMPLE 3

A formulation suitable for use in the present invention is prepared as described below. Table 6 shows the latex portion of the formulation.

TABLE 6

| | Dry | | Wet |
|---|---|---|---|
| Ingredient | Weight | % Solids | Weight |
| Synthetic rubber latex NS-104 cold latex | 50 | 70 | 71.429 |
| K-Stearate | 0.650 | 20 | 3.250 |
| Tall Oil Soap | 2 | 15 | 13.333 |
| HA, LA Ammonia Natural Rubber | 50 | 62 | 80.645 |
| Wingstay L | 1 | 50 | 2 |
| Paraffin Wax | 1 | 50 | 2 |
| TiO₂/titanium dioxide | 0.6 | 60 | 1 |
| Violet blue 369/ultramarine blue | 0.030 | 100 | 0.030 |
| Whiting CC103BLK | 235 | 100 | 235 |
| T-gum AHG Tiarco/polyacrylate | 0.1 | 10 | 1 |
| 30% S.S.F. | 2.4 | 30 | 8 |

The ingredients in Table 6 are blended together in a propeller-type mixer. The latex formulation is stored in tank 108 (FIG. 2). Hydrogen peroxide (35% by weight) is stored in tank 109.

Table 4 above shows the activating agent/accelerator portion of the formulation. The ingredients in Table 4 are blended together in a propeller-type mixer. The activating agent/accelerator formulation is stored in tank 110 (FIG. 2).

The latex formulation in tank 108, the hydrogen peroxide in tank 109 and the activating agent/accelerator formulation in tank 110 are fed to the mixer 116 (FIG. 2). The ratio of the latex formulation and the activating agent/accelerator formulation are such that 10.89 dry weight parts or 22.537 wet weight parts of the activating agent/accelerator formulation (Table 4) are added to the latex formulation (Table 3) at the mixer 116. The ratio of the hydrogen peroxide and latex formulation are such that 5 wet weight parts hydrogen peroxide are added to the latex formulation at the mixer 116. After mixing in the mixer 116, the formulation is applied to the tufted carpet primary backing 12 in the manner described above. The tufted carpet 10 is processed as described above using the apparatus shown in FIG. 2.

The formulation makes a latex foam on the carpet primary backing 12, as described above with respect to FIG. 2. The resulting tufted carpet has an integral foam backing and has excellent properties of bundle penetration and tuft lock.

### EXAMPLE 4

The same procedure is followed as in Example 1 above, except the activating agents shown in Table 7 below are used as the activating agent in the activating agent/accelerator formulation (Table 4) instead of the catalase enzyme.

TABLE 7

| Trial | Activating Agent |
|---|---|
| 1 | Lipase |
| 2 | α-amylase |
| 3 | Glucanase |
| 4 | Dextranase |
| 5 | Lactase |
| 6 | Pectinase |
| 7 | CuCl₂ |
| 8 | CuO |
| 9 | ZnO |
| 10 | MnO₂ |
| 11 | KI |
| 12 | Fe(III) oxide |
| 13 | Baker's yeast |
| 14 | Casein |

The resulting tufted carpet has an integral foam backing and has excellent properties of bundle penetration and tuft lock.

### EXAMPLE 5

The same procedure is followed as in Example 1 above, except the synthetic rubber latexes shown in Table 8 below are used as the film forming polymer in the latex formulation (Table 3) instead of the blend of styrene-butadiene and natural rubber.

TABLE 8

| Trial | Synthetic Rubber Latex |
|---|---|
| 15 | ethylene vinyl acetate |
| 16 | polyvinyl acetate |
| 17 | vinyl acetate |
| 18 | Chloroprene |
| 19 | Neoprene |
| 20 | polyvinyl alcohol |
| 21 | acrylic |
| 22 | styrene acrylic |
| 23 | vinyl acrylic |
| 24 | silicone rubber emulsion |

The resulting tufted carpet has an integral foam backing and has excellent properties of bundle penetration and tuft lock.

### EXAMPLE 6

A formulation suitable for use in the present invention is prepared as described below. Table 9 shows the latex portion of the formulation.

TABLE 9

| | Dry | | Wet |
|---|---|---|---|
| Ingredient | Weight | % Solids | Weight |
| Synthetic Rubber latex | 50 | 70 | 71.429 |
| K-Sterate | 0.650 | 20 | 3.250 |
| Tall Oil Soap | 2 | 15 | 13.333 |
| Low or High Ammonia Natural Rubber | 50 | 62 | 80.645 |
| latex | | | |
| Wingstay L | 1 | 50 | 2 |
| Paraffin Wax | 1 | 50 | 2 |
| TiO₂/titanium dioxide | 0.6 | 60 | 1 |
| Violet blue 369/ultramarine blue | 0.030 | 100 | 0.030 |
| Water | 0 | 0 | 3 |
| B20F Starch | 3 | 100 | 3 |
| Whiting CC103BLK | 235 | 100 | 235 |
| T-gum AHG Tiarco/polyacrylate | 0.1 | 10 | 1 |
| 30% S.S.F. | 2.4 | 30 | 8 |

In Table 9 above, B20F Starch is unmodified corn starch from native yellow dent corn, commercially available from Grain Processing Corporation, Muscatine, Iowa.

The ingredients in Table 9 are blended together in a propeller-type mixer. The latex formulation (Table 9) is stored in tank 108 (FIG. 2). 35% by weight hydrogen peroxide is stored in tank 109.

Table 4 above shows the activating agent/accelerator portion of the formulation. The ingredients in Table 4 are blended together in a propeller-type mixer. The activating agent/accelerator formulation is stored in tank 110 (FIG. 2).

The latex formulation in tank 108, the hydrogen peroxide stored in tank 109 and the activating agent/accelerator formulation in tank 110 are fed to the monitored static mixer 116 (FIG. 2). The ratio of the latex formulation and the activating agent/accelerator formulation are such that 10.89 dry weight parts or 22.537 wet weight parts of the activating agent/accelerator formulation (Table 4) are added to the latex formulation (Table 9) at the mixer 116. The ratio of the hydrogen peroxide and latex formulation are such that 5 wet weight parts hydrogen peroxide are added to the latex formulation at the mixer 116. After mixing in the mixer 116, the formulation is applied to the tufted carpet primary backing 12 in the manner described above. The tufted carpet 10 is processed as described above using the apparatus 100, shown in FIG. 2.

The formulation makes a latex foam on the carpet primary backing 12, as described above with respect to FIG. 2. The resulting tufted carpet has an integral foam backing and has excellent properties of bundle penetration and tuft lock.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A composition comprising:
an aqueous emulsion or solution of a natural or synthetic film-forming polymer;
hydrogen peroxide;
a surfactant; and
an activating agent which causes said hydrogen peroxide to release oxygen gas sufficient to produce a foam.

2. The composition of claim 1, wherein said aqueous emulsion is a latex emulsion.

3. The composition of claim 1, wherein said film forming polymer is selected from styrene-butadiene, carboxylated styrene-butadiene, ethylene vinyl acetate, polyvinyl acetate, vinyl acetate, polyvinyl chloride, chloroprene, neoprene, silicone rubber, natural rubber, polyvinyl alcohol, polyvinyl alcohol stabilized with bromine, acrylic, styrene acrylic, vinyl acrylic, or mixtures thereof.

4. The composition of claim 1, wherein said activating agent is selected from a protein or an oxidizing/reducing agent.

5. The composition of claim 1, wherein said activating agent is an enzyme.

6. The composition of claim 1, wherein said activating agent is selected from catalase, chymotrypsin, lipase, rennet, trypsin, actinidin, α-amylase, β-amylase, bromelain, β-glucanase, ficin, lipoxygenase, papain, asparaginase, glucose isomerase, penicillin amidase, protease, pullulanase, aminoacylase, glucoamylase, cellulase, dextranase, glucose oxidase, lactase, pectinase, pectin lyase, protease, raffinase, invertase, or mixtures thereof.

7. The composition of claim 1, wherein said activating agent is catalase.

8. The method of claim 1, wherein said activating agent is a yeast.

9. The method of claim 1, wherein said activating agent is Saccharomyces cerevisiae.

10. The composition of claim 1, wherein said activating agent is selected from CuCl₂, CuO, ZnO, MnO₂, KI, Fe(II) oxides, Fe(III) oxides, or iron oxide-bearing clay.

11. The composition of claim 1, wherein said aqueous emulsion or solution of a natural or synthetic film-forming polymer comprises about 60% to about 99% by weight of said composition.

12. The composition of claim 1, wherein said hydrogen peroxide comprises about 0.5% to about 40% by weight of said composition.

13. The composition of claim 1, wherein said activating agent comprises about 0.05% to about 5% by weight of said composition.

14. The composition of claim 1 further comprising one or more additive selected from an accelerator, a vulcanizing agent or a gelling agent.

15. The composition of claim 14, wherein said additive comprises about 0.5% to about 10% by weight of said composition.

16. The composition of claim 1 further comprising an effective amount of starch.

17. The composition of claim 13, wherein said starch comprises about 0.2% to about 3% by weight of said composition.

18. The composition of claim 1 further comprising stearic acid or salts thereof.

19. The composition of claim 18, wherein said stearic acid or salts thereof comprises about 0.10% to about 3% by weight of said composition.

20. The composition of claim 1 further comprising an inorganic filler.

21. The composition of claim 17, wherein said inorganic filler comprises up to about 70% by weight of said composition.

22. The composition of claim 2, wherein said latex emulsion is a blend of natural rubber latex and synthetic rubber latex.

23. The composition of claim 2, wherein said latex emulsion is 100% synthetic rubber latex.

24. The composition of claim 1 further comprising a time-based gelling agent.

25. The composition of claim 1, wherein said surfactant comprises about 0.0025% to about 3% by weight of said composition.

26. A composition comprising:
about 100 dry weight parts of an aqueous emulsion or solution of a natural or synthetic film-forming polymer;
about 1.75 dry weight parts hydrogen peroxide;
about 10 dry weight part of a gelling agent;
about 1 dry weight parts of an activating agent; and
about 0.06 dry weight parts of a surfactant.

27. A method of making a latex foam comprising combining a latex emulsion, hydrogen peroxide, a surfactant and an activating agent, whereby said activating agent causes said hydrogen peroxide to release oxygen gas in said latex emulsion sufficient to produce a latex foam.

28. The method of claim 27, wherein said latex composition contains up to about 87% by weight solids.

29. The method of claim 26 further comprising drying and curing said latex foam.

30. A method comprising applying to a textile material a composition comprising an aqueous emulsion or solution of a natural or synthetic film-forming polymer, hydrogen peroxide, a surfactant and an activating agent, whereby said activating agent causes said hydrogen peroxide to release oxygen gas in said composition thereby producing a latex foam.

31. The method of claim 30, wherein said aqueous emulsion or solution of a natural or synthetic film-forming polymer is a latex emulsion.

32. The method of claim 30, wherein said film forming polymer is selected from styrene-butadiene, carboxylated styrene-butadiene, ethylene vinyl acetate, polyvinyl acetate, vinyl acetate, polyvinyl chloride, chloroprene, neoprene, silicone rubber, natural rubber, polyvinyl alcohol, polyvinyl alcohol stabilized with bromine, acrylic, styrene acrylic, vinyl acrylic, or mixtures thereof.

33. The method of claim 30, wherein said aqueous emulsion or solution of a natural or synthetic film-forming polymer comprises about 60% to about 99% by weight of said composition.

34. The method of claim 30, wherein said hydrogen peroxide comprises about 0.5% to about 40% by weight of said composition.

35. The method of claim 30, wherein said activating agent comprises about 0.05% to about 5% by weight of said composition.

36. The method of claim 30, wherein the composition comprises about 100 dry weight parts latex emulsion, about 1.75 dry weight parts hydrogen peroxide, about 1 dry weight parts activating agent and about 0.06 dry weight parts of a surfactant.

37. The method of claim 30, wherein the composition further comprises a gelling agent.

38. The method of claim 30, wherein the composition comprises about 0.20% to about 3% by weight of a gelling agent.

39. The method of claim 30, wherein said composition contains up to approximately 87% by weight solids.

40. The method of claim 30 further comprising drying and curing said latex foam.

41. The method of claim 30, wherein said textile is a carpet.

42. A latex foam-coated textile made by the process of claim 30.

43. A latex foam made by the process of claim 27.

44. A latex foam-coated carpet made by the process of claim 30.
